(19) United States
(12) Patent Application Publication
(10) Pub. No.: US 2025/0123874 A1
(43) Pub. Date: Apr. 17, 2025

(54) METHODS AND APPARATUS TO CONFIGURE VIRTUAL MACHINES

(71) Applicant: VMware LLC, Palo Alto, CA (US)

(72) Inventors: Vishal Gupta, Ludhiana (IN); Manish Jain, Faridabad (IN); Umedh Shriram Meshram, Pune (IN); Sachin Mahajan, Pune (IN); Pranali Pravin Lokare, Pune (IN); Saifuddin Fazlehusen Rangwala, Pune (IN)

(21) Appl. No.: 18/648,112

(22) Filed: Apr. 26, 2024

(30) Foreign Application Priority Data
Oct. 14, 2023 (IN) 202341069322

(51) Int. Cl. G06F 9/455

(52) U.S. Cl. CPC G06F 9/45558; G06F 2009/45591

(57) ABSTRACT

Methods and apparatus to configure virtual machines (VMs) are disclosed. Am example system to manage a plurality of virtual machines of a shared computing resource, the system includes interface circuitry, programmable circuitry, and machine readable instructions to cause the programmable circuitry to at least one of scan or monitor the plurality of virtual machines, determine whether a master application corresponding to the virtual machines has accepted a minion application corresponding to a first one of the virtual machines, and in response to the determination that the master application has not accepted the minion application, cause the master application to accept the minion application.

### RELATED APPLICATIONS

This application claims priority to Indian application Ser. No. 202341069322 filed Oct. 14, 2023, by VMware LLC, entitled “METHODS AND APPARATUS TO CONFIGURE VIRTUAL MACHINES,” which is hereby incorporated by reference in its entirety for all purposes.

### FIELD OF THE DISCLOSURE

This disclosure relates generally to distributed computing and, more particularly, to methods and apparatus to configure virtual machines.

### BACKGROUND

In recent years, cloud-based systems have enabled distribution and scalability of computational services and/or resources. Particularly, microservice architectures utilize a cloud-based approach in which execution of a single application is composed of independently and/or discretely deployable smaller components or services referred to as microservices. To that end, virtual machines (VMs) can be utilized on cloud services. VMs are typically installed with applications that are configured for proper operation and/or communication thereof.

### BRIEF DESCRIPTION OF THE DRAWINGS

FIG. 1 is a block diagram of an example environment in which an example virtual machine (VM) manager device in accordance with teachings of this disclosure can be implemented.

FIG. 2 is an example architecture that can be implemented with the example VM manager device of FIG. 1.

FIG. 3 is an example process flow of the example VM manager device of FIG. 1.

FIG. 4 is a block diagram of a VM configuration analysis system that can be implemented in examples disclosed herein.

FIGS. 5 and 6 are flowcharts representative of example machine readable instructions and/or example operations that may be executed, instantiated, and/or performed by example programmable circuitry to implement the example VM configuration analysis system of FIG. 4.

FIG. 7 is a block diagram of an example processing platform including programmable circuitry structured to execute, instantiate, and/or perform the example machine readable instructions and/or perform the example operations of FIGS. 5 and 6 to implement the VM configuration analysis system of FIG. 4.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 5 and 6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Methods and apparatus to configure virtual machines (VMs) are disclosed. VMs can be utilized on cloud services that are associated with relatively large enterprises having a relatively complex infrastructure. In particular, the cloud services can implement thousands of VMs that are utilized across multiple cloud providers or private clouds. Proper operation of an enterprise necessitates that nearly all of the VMs thereof are properly configured and compliant (e.g., with internal policies and regulatory requirements).

However, manually installing and configuring applications/software on each VM and ensuring that the applications/software remain compliant can utilize significant resources and can be time-consuming, error-prone, and difficult to scale. Additionally, there is a risk that a user with administrative access to a virtual machine may access and/or modify data that the user is usually not permitted to access (e.g., in violation of compliance and/or security requirements). Further, a VM can be altered and/or misconfigured to be non-compliant or malfunctioning.

Examples disclosed herein enable efficient and effective configuration of infrastructure and/or shared computing resources that utilize VMs, such as cloud services. Examples disclosed herein can efficiently scan/monitor VMs of a shared computing resource and configure the VMs in a relatively quick manner to reduce downtime and/or delays typically necessitated for installation and/or remediation. As a result, time-consuming and slow configuration processes of the VMs can be eliminated. Further, examples disclosed herein can enable maintenance and/or monitoring of VMs for enforcement and/or compliance requirements. Examples disclosed herein can also reduce downtime and/or malfunction of VMs of shared resources (e.g., cloud-based services, multi-cloud-based services, etc.).

Examples disclosed herein can manage a plurality of VMs of a shared computing resource, such as one or more cloud services, for example. Examples disclosed herein scan/monitor the cloud service(s) and/or VMs associated with the cloud service(s) to determine whether a master application installed on at least one of the VMs has accepted a minion application of a VM. In response to the determination that the master application has not accepted the minion application, the master application is caused and/or directed to accept the minion application, for example. The acceptance of the minion application by the master application can pertain to a proper establishment of communication therebetween, a proper configuration of the minion application and/or the master application, etc. According to some examples disclosed herein, the master application is directed to accept the minion application by causing the master application to accept a key (e.g., a key identifier) of the minion application. As a result, the minion application of the VM can properly operate and communicate/interface with the master application (e.g., provide information/updates to the master application).

In some examples, the VMs are scanned/monitored (e.g., periodically, based on a schedule, based on an event/trigger, substantially in real time, etc.) to ensure that each of the VMs has a corresponding minion application installed thereon. Additionally or alternatively, it is determined that at least one of the VMs has the master application installed thereon. In some examples, each minion application corresponding to the VMs is scanned/monitored for proper compliance thereof including, but not limited to, proper configuration (e.g., a proper configuration state, proper configuration settings, proper configuration parameter values, etc.), proper installation, proper software version, etc. Accordingly, based on the minion application being non-compliant, an adjustment of the configuration can be performed and/or the minion application can be updated or re-installed. As a result, the VM corresponding to the minion application is properly configured for communication/authentication with the master application, as well as compliance/enforcement requirements.

In some examples, the enforcement of the compliance/enforcement requirements is performed by providing an enforcement instructions/request to a configuration service associated with infrastructure of the shared computing resource. In some examples, the VM is scanned and/or monitored based on and/or in response to a request to enforce a state and/or a configuration of the VM via the aforementioned infrastructure.

As used herein, the terms “master application” or “master” refer to an application that directs, controls, accesses and/or collects data from one or more subordinate components and/or applications. As used herein, the terms “minion application” or “minion” refer to a client application that is subordinate to a master application. Accordingly, the term “minion application” can refer to client agent that is managed by a master application.

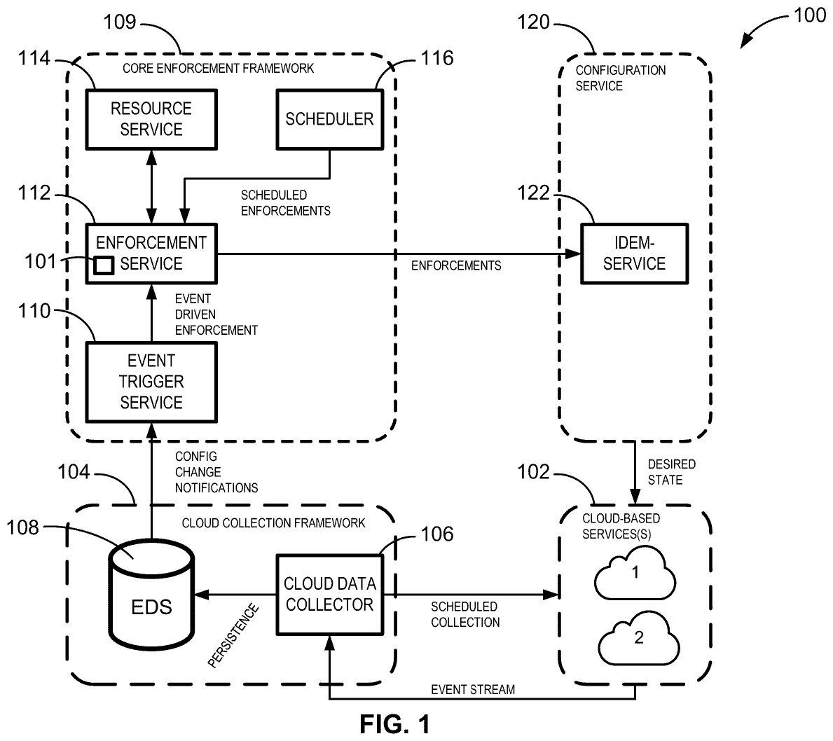

FIG. 1 is a schematic block diagram of an example environment 100 in which an example VM manager device 101 that operates to manage and/or configure VMs of a shared computing resource can be implemented. In the illustrated example of FIG. 1, aspects and/or components of the environment 100 function as a system that manages operations and usage of at least one cloud-based service 102. The management of the operations can pertain to configuring settings, managing resource usage and/or managing access of the cloud-based service(s) 102. The example architecture shown in the example of FIG. 1 is only an example and any appropriate other architecture, network, control scheme, communication and/or data topology can be implemented instead.

According to examples disclosed herein, an example cloud collection framework 104 includes an example cloud data collector 106 to coordinate and communicate with the cloud-based service(s) 102. To that end, the example cloud data collector 106 can extract, receive and/or query information (e.g., components, metadata, services, service information) from the cloud-based service(s) 102. In this example, the cloud data collector 106 can request and/or direct the cloud-based service(s) 102 to provide information related to: (1) accounts utilizing the cloud-based service(s) 102, (2) at least one configuration of the cloud-based service(s) 102 and/or (3) services of the cloud-based service(s) 102. The request by the cloud data collector 106 to the cloud-based service(s) 102 can be driven by an occurrence of an event or performed on periodic or aperiodic timeframes and/or on a schedule. According to examples disclosed herein, the cloud-based service(s) 102 provide(s) data, requested changes, configuration information and/or updates associated with the cloud-based service(s) 102 to the cloud data collector 106 in response to a query from the cloud data collector 106 or without receiving a query from the cloud data collector 106. In some examples, the aforementioned data and/or updates provided to the cloud data collector 106 can include changes of a configuration of the cloud-based service(s) 102 and/or operational data of the cloud-based service(s) 102.

In this example, the aforementioned cloud collection framework 104 also includes an example entity data service (EDS) 108. The example EDS 108 can be implemented as a database, data store, database manager and/or database framework to store and/or collect data associated with the cloud-based service(s) 102. The example EDS 108 stores entity data of the cloud-based service(s) 102 in a normalized form (e.g., as a centralized repository). According to examples disclosed herein, the EDS 108 can provide any requested or proposed configuration change request to a core enforcement framework 109 which, in turn, includes an example event trigger service 110 that implements the aforementioned example VM manager device 101, an example enforcement service 112, an example resource service 114 and an example scheduler 116. For example, when an event occurs, such as a rule change and/or a configuration change corresponding to the cloud-based service(s) 102, a notification from the EDS 108 is provided to the event trigger service 110.

The event trigger service 110 of the illustrated example is implemented to direct enforcement, configuration changes and/or access to services (e.g., microservices) of the cloud-based service(s) 102. The example event trigger service 110 can map a configuration change event to a desired state of the cloud service(s). Accordingly, the example event trigger service 110 can direct control, usage and/or configuration of the cloud-based service(s) 102 via (or in conjunction with) the aforementioned enforcement service 112. In this example, the event trigger service 110 provides requests and/or commands pertaining to event-driven enforcement of the cloud-based service(s) 102 to the enforcement service 112. In some examples, the event trigger service 110 manages and/or directs changes to key value data stores. In some examples, the event trigger service 110 can utilize and/or implement a Kubernetes cluster.

The example enforcement service 112 determines, manages and provides enforcements (e.g., configuration changes, access changes, resource usage instructions, a desired state change, etc.) with respect to the cloud-based service(s) 102 to a configuration service 120 based on the event-driven enforcements and/or instructions received from the event trigger service 110. Additionally or alternatively, notifications (e.g., configuration change notifications), enforcements and/or instructions received from the resource service 114 and the scheduler 116 cause the enforcement service 112 to provide enforcements to the configuration service 120. In turn, the enforcements provided to the configuration service 120 are subsequently provided to the cloud-based service(s) 102 as desired state changes (e.g., desired state change instructions or directives).

In this example, the resource service 114 stores and/or manages operational data and/or settings of the cloud-based service(s) 102. In this example, the resource service 114 contains, analyzes and/or manages metadata of the cloud-based service(s) 102 that is utilized to manage the cloud-based service(s) 102. In particular, the metadata corresponds to settings, access information and/or configurations of the cloud-based service(s) 102, for example.

In some examples, the aforementioned scheduler 116 directs and/or manages scheduled implementations, configuration changes, enforcements and/or updates (e.g., periodic updates) of the cloud-based service(s) 102 via the example enforcement service 112 and the configuration service 120. For example, the scheduler 116 can schedule the enforcement service 112 to perform scheduled enforcements of the configuration service 120 which, in turn, controls and/or directs a desired state of the cloud-based service(s) 102.

To control, manage, enforce and/or direct operation of the cloud-based service(s) 102, as mentioned above, the example enforcement service 112 provides the enforcements to the configuration service 120. In this example, the configuration service 120 includes an idempotent (IDEM) service 122 that is distinct from the core enforcement framework 109 and, thus, the enforcement service 112. However, the IDEM service 122 can be integrated with the enforcement service 112 and/or the core enforcement framework 109 in other examples. In the illustrated example of FIG. 1, the IDEM service 122 is an implementation/provisioning engine that implements desired state changes with respect to the cloud-based service(s) 102. In other words, the IDEM service 122 controls a desired state of the cloud-based service(s) 102 based on enforcements provided from the enforcement service 112. While the VM manager device 101 is shown implemented in the example enforcement service 112, additionally or alternatively, the VM manager device 101 can be implemented in the example event trigger service 110, the resource service 114 and/or the scheduler 116.

As mentioned above, any appropriate data topology, architecture and/or structure can be implemented instead. Further, any of the aforementioned aspects and/or elements described in connection with FIG. 1 can be combined or separated as appropriate. Further, while examples disclosed herein are shown in the context of cloud services, examples disclosed herein can be implemented in conjunction with any appropriate distributed and/or shared computing resource system.

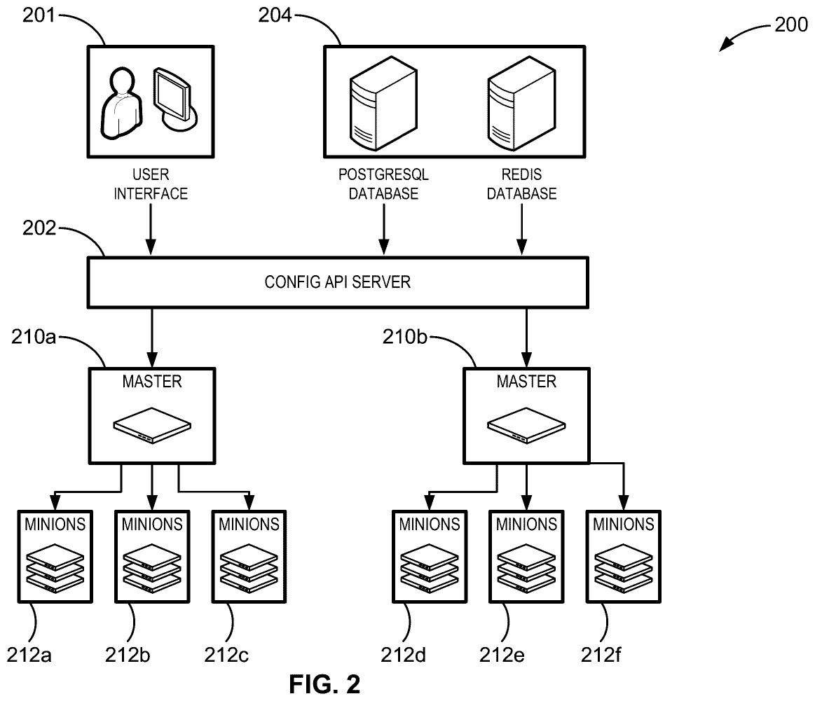

FIG. 2 is an example architecture 200 that can be implemented with the example VM manager device 101 of FIG. 1. As can be seen in the illustrated example of FIG. 2, a user interface (e.g., an administrator interface) 201 is shown communicatively couped to a configuration server 202, which can be implemented as a stack configuration application programming interface (API) server, for example. Further, databases 204 are utilized by the configuration server 202. In turn, master applications (e.g., manager applications, management applications, masters, etc.) 210 (hereinafter master applications 210a, 210b, etc.) are shown directing and/or being communicatively coupled to groupings of minion applications (e.g., client applications, client agents, client managers, minions, etc.) 212 (hereinafter minion applications 212a, 212b, 212c, 212d, 212e, 212f, etc.). While two of the master applications 210 are shown implemented with six groupings of the minion applications 212, any other appropriate numbers of the master applications 210 and the minion applications 212 can be implemented.

The example architecture 200 of FIG. 2 corresponds to an infrastructure management system, which can be implemented by the Salt management system by VMware® that is utilized to manage infrastructure. However, any other appropriate architecture, topology and/or hierarchy can be implemented instead. According to examples disclosed herein, the infrastructure management system is utilized for remote execution, configuration management, and/or infrastructure automation. Accordingly, the aforementioned minion applications 212 are client agents of the infrastructure management system. The minion applications 212 are installed on each VM managed by the infrastructure management system, and multiple ones of the minion applications 212 communicate with the corresponding master applications 210 to receive commands, execute tasks, and report back their status, etc. Applications and/or software of the aforementioned infrastructure management system can run as a background process on each managed system and/or VM and can provide a set of functions that the master applications 210 can utilize to manage and automate various aspects of the infrastructure management system. These functions may include package installation, configuration file management, software deployment, and numerous other system administration tasks, for example. When one of the minion applications 212 initializes and/or starts up, this minion application 212 contacts the corresponding master application 210 and establishes a secure communication channel to receive instructions and return (e.g., provide back) information/data (e.g., as reports) to the corresponding master application 210. In turn, the example master application 212 can then utilize remote execution framework to issue commands and run tasks on the corresponding minion applications 212.

In this example, the minion applications 212 are relatively configurable and can be customized to meet specific needs/requirements of each managed system. Accordingly, the minion applications 212 can be configured to run specific modules, execute scheduled tasks, and perform other automated tasks as directed, requested and/or necessitated. With configuration management features of the infrastructure management system, administrators can define the desired state of their managed distributed computing systems.

According to examples disclosed herein, certain prerequisites can be utilized including, but not limited to, setting up at least one of: the master applications 210 to manage, control and/or direct corresponding multiple VMs, ones of the minion applications 212 to be installed on each VM, such that for cloud-based frameworks, metadata grains can be necessitated to be exposed. Accordingly, the corresponding master application 210 can be configured with pre-defined and/or necessitated modules and states to enforce compliance on the VMs. In some examples, a set of predefined rules and policies are defined to ensure compliance with industry standards and organizational policies, and/or access to the VMs via secure shell socket (SSH) or other remote access mechanisms, etc.

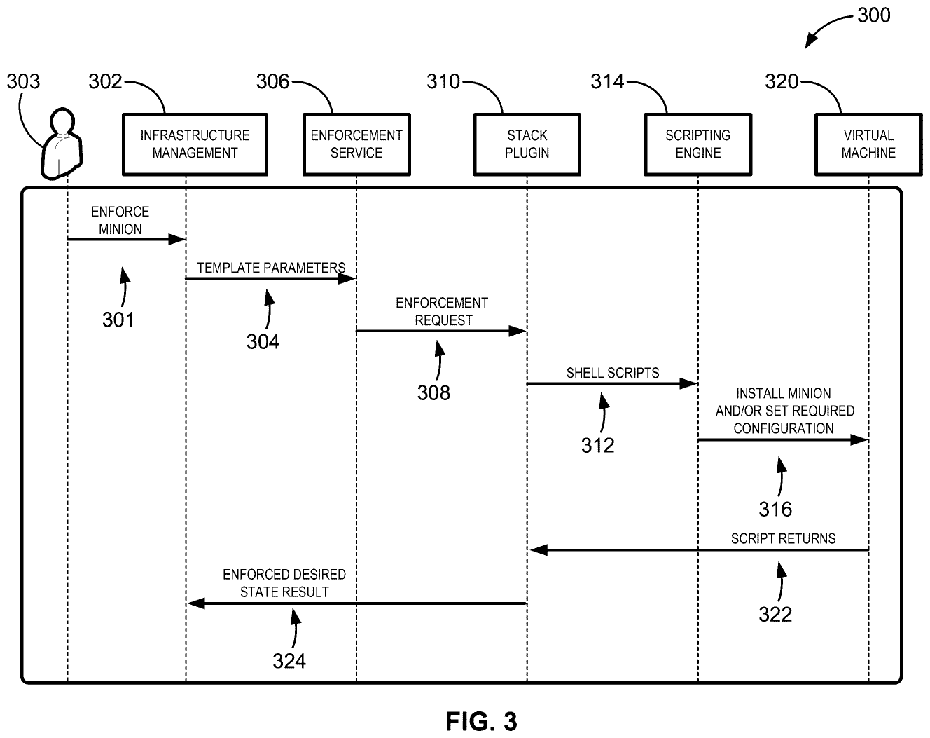

FIG. 3 is an example process flow 300 of the example VM manager 101 device of FIG. 1. In the illustrated example of FIG. 3, at step 301, a request to enforce configuration and/or installation of a minion application (e.g., the minion application 212) is received at an infrastructure management system/interface 302, which can be implemented as the environment 100 of FIG. 1, from an administrator (e.g., an infrastructure administrator, a cloud administrator, etc.) 303. In turn, at step 304, the infrastructure management system/interface 302 provides templates and/or parameters to an enforcement service 306, which can be implemented by the example enforcement service 112 shown in FIG. 1. According to examples disclosed herein, at step 308, an enforcement request is forwarded from the enforcement service 306 to a stack plugin 310 which, in turn, at step 312, provides shell scripts to a scripting engine 314. In this example, at step 316, the scripting engine 314 installs and/or sets requirements of at least one VM 320 (e.g., of the cloud-based services 102 shown in FIG. 1).

According to examples disclosed herein, at step 322, the VM 320 returns information/data (e.g., information/data corresponding to script returns) to the example stack plugin 310. In turn, at step 324, the example stack plugin 310 provides a result related to a desired enforcement state of the VM to the infrastructure management system/interface 302 (e.g., corresponding to the cloud data collector 106 and/or the EDS 108 shown in FIG. 1).

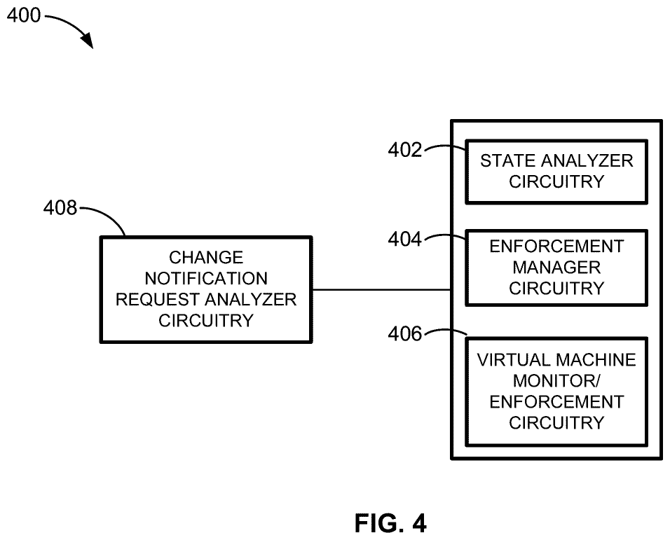

FIG. 4 is a block diagram of an example VM configuration analysis system 400 that can be implemented in the VM manager device 101 of FIG. 1 to manage and operate VMs of a shared computing resource, such as a cloud-based service (e.g., the cloud-based service(s) 102 shown in FIG. 1). The VM configuration analysis system 400 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the VM configuration analysis system 400 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

The VM configuration analysis system 400 of the illustrated example includes example state analyzer circuitry 402, example enforcement manager circuitry 404, example VM monitor circuitry 406, and a change notification request analyzer circuitry 408.

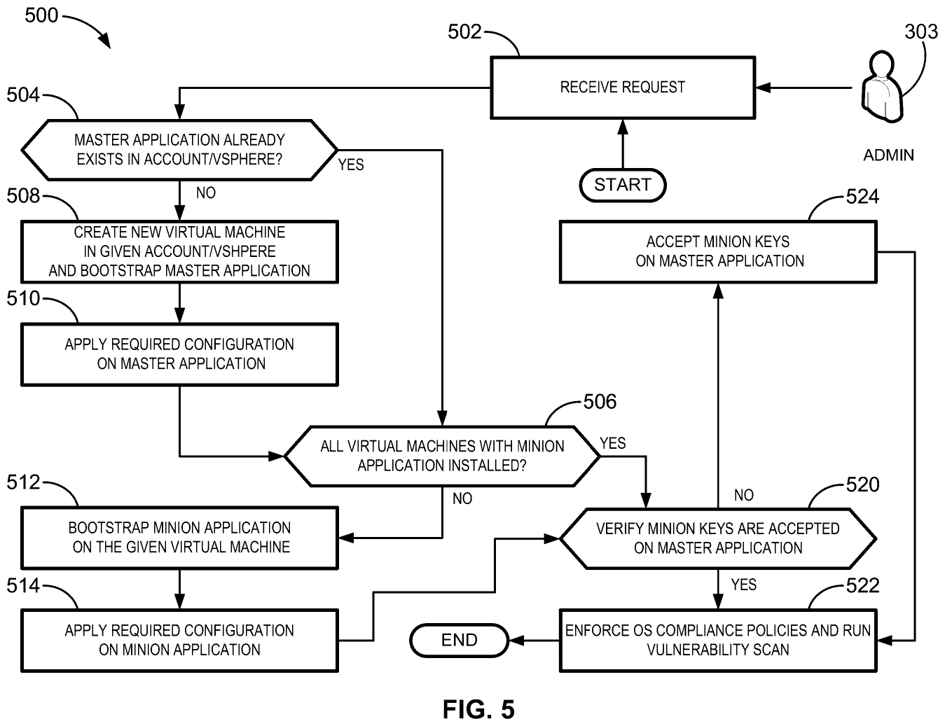

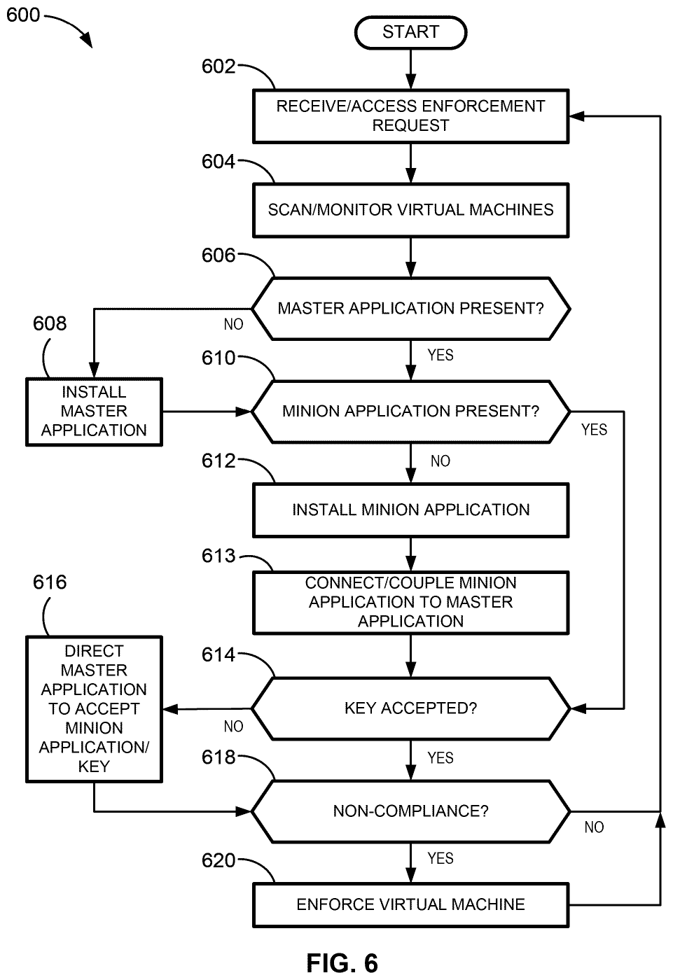

According to examples disclosed herein, the state analyzer circuitry 402 is implemented to determine whether a master application is installed and/or exists on the shared computing resource. In this particular example, the state analyzer circuitry 402 determines that a grouping, arrangement and/or cluster of VMs includes at least one master application to direct, control and/or obtain information from corresponding minion applications. Further, the example state analyzer circuitry 402 is to determine whether each VM includes at least one minion application installed thereon and/or whether the minion applications installed onto each of the VMs are properly correctly/appropriately configured. According to examples disclosed herein, the example state analyzer circuitry 402 can scan and/or monitor (e.g., in substantially real time) the VMs for (i) each VM having a corresponding minion application, (ii) at least one master application being installed onto a shared resource (e.g., a VM cluster) and/or (iii) the minion application installed onto the corresponding VMs being properly configured, etc. In some examples, the state analyzer circuitry 402 is instantiated by programmable circuitry executing state analyzer instructions and/or configured to perform operations such as those represented by the flowcharts of FIGS. 5 and 6.

The example enforcement manager circuitry 404 is implemented to enforce proper installation, configuration and/or operation of the master application and its corresponding minion application(s). In some examples, the enforcement manager circuitry 404 is to install the master application and/or at least one minion application when either is not installed on a VM of the shared computing resource. In a particular example, when the master application is not installed onto at least one VM of the shared computing resource (as determined by the state analyzer circuitry 402), the enforcement manager circuitry 404 installs and configures the master application onto the shared computing resource. Further, the example enforcement manager circuitry 404 is to configure and/or install a minion application onto a corresponding VM based on a determination by the state analyzer 402 that the minion application is not installed and/or is improperly configured. In a specific example, the enforcement manager circuitry 404 determines versions (e.g., build versions) of the master application and/or the minion application(s). In some examples, the enforcement manager circuitry 404 is instantiated by programmable circuitry executing enforcement manager instructions and/or configured to perform operations such as those represented by the flowcharts of FIGS. 5 and 6.

In some examples, the example VM monitor circuitry 406 is implemented to scan and/or monitor (e.g., periodically monitor, continuously monitor, event-based monitor, etc.) a status, configuration and/or operation of the VMs. Accordingly, the example VM monitor circuitry 406 can operate to periodically and/or continuously ensure that each VM of the shared computing resource has at least a corresponding minion application that is, in turn, coupled to and/or configured to communicate with a respective master application. Additionally or alternatively, the VM monitor circuitry 406 is to monitor and/or scan the VMs to determine that the minion applications and the master application are properly configured and/or operating with specifications, operating requirements and/or compliance requirements, etc. In some examples, the VM monitor circuitry 406 is instantiated by programmable circuitry executing VM monitor instructions and/or configured to perform operations such as those represented by the flowcharts of FIGS. 5 and 6.

The change notification request analyzer circuitry 408 of the illustrated example is implemented to communicate and/or interface with the configuration service 120 and/or the IDEM-service 122 of FIG. 1 so that enforcement and/or change requests can be provided to the VM configuration analysis system 400 and/or the example state analyzer circuitry 402. In particular, the request analyzer circuitry 408 can determine requested configuration changes of the VMs and/or the corresponding minion application(s). Additionally or alternatively, the change notification request analyzer circuitry 408 provides information regarding a state/configuration of a minion application to the state analyzer circuitry 402 (e.g., for enforcement/compliance purposes). In some examples, the change notification request analyzer circuitry 408 is instantiated by programmable circuitry executing change notification request analyzer instructions and/or configured to perform operations such as those represented by the flowcharts of FIGS. 5 and 6.

Examples disclosed herein can scan minion applications for According to examples disclosed herein, an example pseudocode can be implemented as follows:
{% set minion_id=params.get(‘minion_id’, ‘test_minion_id’) %}
{{minion_id}}:
saltstack.minion.present:
-minion_id: {{minion_id}}
-instance_id: i-0235950a8e224fe89
minion_version: 3004.1
   However, any other appropriate algorithm, methodology and/or processing of can be utilized with respect to the VMs and/or minion applications installed thereon.

While an example manner of implementing the VM configuration analysis system 400 of FIG. 1 is illustrated in FIG. 4, one or more of the elements, processes, and/or devices illustrated in FIG. 4 may be combined, divided, re-arranged, omitted, eliminated, and/or implemented in any other way. Further, the example state analyzer circuitry 402, the example enforcement manager circuitry 404, the example VM monitor circuitry 406, the example change notification request analyzer circuitry 408, and/or, more generally, the example VM configuration analysis system 400 of FIG. 4, may be implemented by hardware alone or by hardware in combination with software and/or firmware. Thus, for example, any of the example state analyzer circuitry 402, the example enforcement manager circuitry 404, the example VM monitor circuitry 406, the example change notification request analyzer circuitry 408, and/or, more generally, the example VM configuration analysis system, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example VM configuration analysis system 400 of FIG. 4 may include one or more elements, processes, and/or devices in addition to, or instead of, those illustrated in FIG. 4, and/or may include more than one of any or all of the illustrated elements, processes and devices.

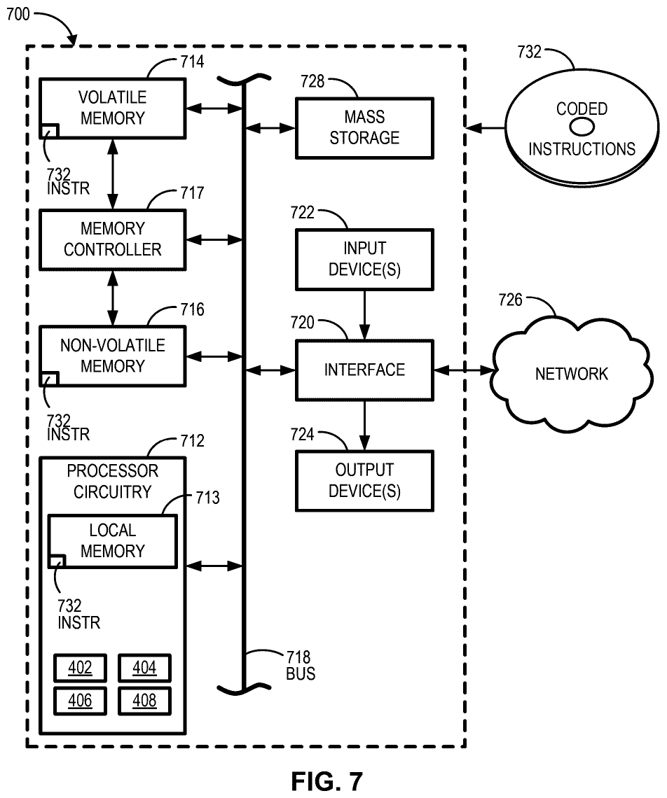

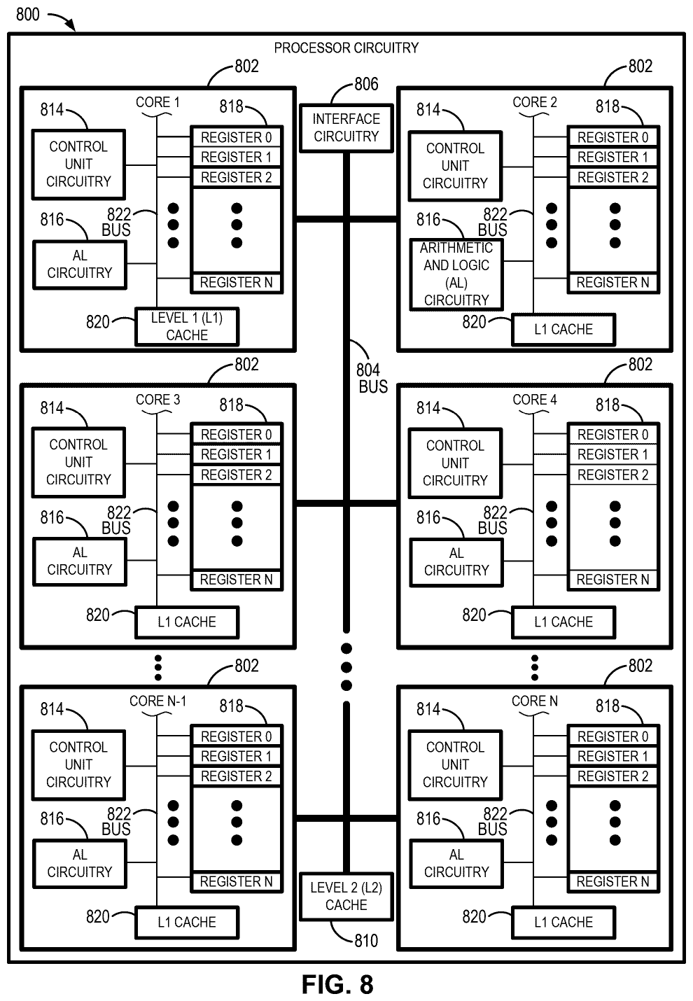

Flowchart(s) representative of example machine readable instructions, which may be executed by programmable circuitry to implement and/or instantiate the VM configuration analysis system 400 of FIG. 4 and/or representative of example operations which may be performed by programmable circuitry to implement and/or instantiate the VM configuration analysis system 400 of FIG. 4, are shown in FIGS. 5 and 6. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5 and 6, many other methods of implementing the example VM configuration analysis system 400 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 5 and 6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 5 is a flowchart representative of example machine readable instructions and/or example operations 500 that may be executed, instantiated, and/or performed by programmable circuitry to manage a VM infrastructure, such as a shared computing resource (e.g., a cloud-based resource). The method 500 of the illustrated example corresponds to configuring, monitoring and/or installing VM management software/architecture for each VM of the shared computing resource. Additionally or alternatively, the example operations 500 can be utilized to monitor and/or enforce compliance of ones of the VMs of the shared resource. The example machine-readable instructions and/or the example operations 500 of FIG. 5 begin at block 502, at which the example state analyzer circuitry 402 and/or the example change notification request analyzer circuitry 408 receives and/or accesses a request (e.g., an enforcement request, a compliance request, etc.) to configure and/or install an application on at least one of the VMs is received. In particular, the application can be a master application or a minion application.

At block 504, in this example, it is determined by the state analyzer circuitry 402 as to whether the master application is present/exists (e.g., installed) on an account, a vSphere, a cloud system/unit and/or a VM. If the master application is present (e.g., installed) (block 504), the process proceeds to block 506. Otherwise, the process proceeds to block 508.

At block 506, according to examples disclosed herein, if the state analyzer circuitry 402 determines that the master application is present/installed (block 504), the VM monitor circuitry 406 scans the VMs (e.g., scans each of the VMs) and the state analyzer circuitry 402 determines whether minion applications are installed on the VMs (e.g., the minion applications are installed on each of the VMs). In this example, all VMs of the shared computing resource are scanned by the VM monitor circuitry 406. If the minion application is installed (block 506), the process proceeds to block 520. Otherwise, the process proceeds to block 512.

At block 508, if the master application is determined to not be present/installed by the state analyzer circuitry 402 (block 504), the example enforcement manager circuitry 404 creates and/or defines a VM (e.g., an account corresponding to a VM of a cloud service) on the shared computing resource and bootstraps the master application to the created and/or defined VM. In other examples, the example enforcement manager circuitry 404 installs and/or defines the master application onto an existing/pre-defined VM and/or a VM already having a minion application installed thereon.

At block 510, in this example, the example enforcement manager circuitry 404 applies a configuration to the master application and/or controls/directs configuration changes to the master application.

At block 512, the example enforcement manager circuitry 404 bootstraps the minion application on at least one VM. In some examples, the minion application is bootstrapped to all VMs of a shared resource.

At block 514, according to examples disclosed herein, a configuration is applied by the example enforcement manager circuitry 404 to the minion application. According to some examples disclosed herein, the example enforcement manager circuitry 404 configures the minion application for proper operation and/or communication with the master application.

At block 520, the example state analyzer circuitry 402 and/or the example VM monitor circuitry 406 determines whether minion keys are accepted on the master application. According to examples disclosed herein, if the minion keys are accepted on the master application (block 520), control of the process proceeds to block 522. Otherwise, the process proceeds to block 524.

At block 522, compliance (e.g., operating system (OS) compliance polices are met) is enforced by the example enforcement manager circuitry 404, and the example VM monitor circuitry 406 performs a vulnerability scan, and the process ends. According to examples disclosed herein, a shared resource (e.g., a cloud resource) and/or VMs corresponding to the shared resource are monitored for compliance by the VM monitor circuitry 406. For example, the VMs may be monitored for a presence and/or installation of a master application and/or a minion application via the VM monitor circuitry 406.

At block 524, in some examples, if the key of the minion application is not accepted on the master application (block 520), the master is directed by the example enforcement manager circuitry 404 to accept the key of the corresponding minion application.

FIG. 6 is a flowchart representative of example machine readable instructions and/or example operations 600 that may be executed, instantiated, and/or performed by programmable circuitry to manage a VM infrastructure. Aspects of the machine readable instructions and/or example operations 600 can be combined with aspects of the machine readable instructions and/or example operations 500 (and vice-versa).

At block 602, according to some examples disclosed herein, the example state analyzer circuitry 402 and/or the example VM monitor circuitry 406 receives/accesses an enforcement request. In this example, the enforcement request is received via the event trigger service 110 and/or the EDS 108 shown in FIG. 1. In some examples, the enforcement request corresponds to a requested change in state and/or configuration of the cloud-based service(s) 102 of FIG. 1.

At block 604, in this example, the VM monitor circuitry 406 scan/monitors VMs. In this example, the VM monitor circuitry 406 can periodically scan and/or monitor the VMs for compliance, a presence of a master application for a cluster/sphere/group of VMs, proper configurations of master applications and minion applications, etc. Additionally or alternatively, the VM monitor circuitry 406 can scan and/or monitor the VMs (or a group of designated/assigned VMs) based on an event, such as an enforcement request (e.g. via the event trigger service 110 and/or the EDS 108 shown in FIG. 1).

At block 606, it is determined by the example state analyzer circuitry 402 if a master application is present. If the master application is present and/or installed (block 606), the process proceeds to block 610. Otherwise, the process proceeds to block 608. In this application a grouping/cluster/sphere of VMs is analyzed by the example state analyzer circuitry 402 for a presence of a corresponding master application.

At block 608, the master application is installed by the example enforcement manager circuitry 404 onto at least one of the VMs based on the example state analyzer circuitry 402 determining that the master application is determined to not be installed/present (block 606).

At block 610, the state analyzer circuitry 402 determines if a minion application is present. If the minion application is present (block 610), control of the process proceeds to block 614. Otherwise, the process proceeds to block 612. In this example, the state analyzer circuitry 402 determines that each VM includes a corresponding minion application installed thereon. In some examples, the state analyzer circuitry 402 also determines whether the minion application is connected, communicatively coupled and/or linked to a corresponding master application. In some such examples, the state analyzer circuitry 402 determines that the master application is enabled to communicate and/or receive information from the minion application.

At block 612, the enforcement manager circuitry 404 of the illustrated example installs the minion application onto any VM that does not have a minion application installed thereon.

At block 613, the example enforcement manager circuitry 404 couples, connects, assigns, designates and/or configures the minion application to communicate with a corresponding master application.

At block 614, it is determined by the example state analyzer circuitry 402 as to whether the minion application and/or a key of the minion application is accepted by the master application. If the key is accepted (block 614), control of the process proceeds to block 618. Otherwise, the process proceeds to block 616.

At block 616, example enforcement manager circuitry 404 directs and/or instructs the master application to accept the key. According to some examples disclosed herein, the enforcement manager circuitry 404 identifies and/or forwards the key (e.g., information pertaining to the key) to be accepted by the master application.

At block 618, the example state analyzer circuitry 402 and/or the example VM monitor circuitry 406 determines whether non-compliance and/or misconfiguration of at least one of the VMs is present. If non-compliance and/or misconfiguration is present, control of the process proceeds to block 620. Otherwise, the process returns to block 604.

At block 620, according to some examples disclosed herein, at least one VM is enforced and/or monitored by the enforcement manager circuitry 404 and/or the VM monitor circuitry 406 for compliance and the process returns to block 602 (and/or block 604).

FIG. 7 is a block diagram of an example programmable circuitry platform 700 structured to execute and/or instantiate the example machine-readable instructions and/or the example operations of FIGS. 5 and 6 to implement the VM configuration analysis system 400 of FIG. 4. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the example state analyzer circuitry 402, the example enforcement manager circuitry 404, the example VM monitor circuitry 406, and the example change notification request analyzer circuitry 408.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 5 and 6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 5 and 6 to effectively instantiate the circuitry of FIG. 2 as logic circuits to perform operations corresponding to those machine readable instructions. In some such examples, the circuitry of FIG. 4 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 5 and 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

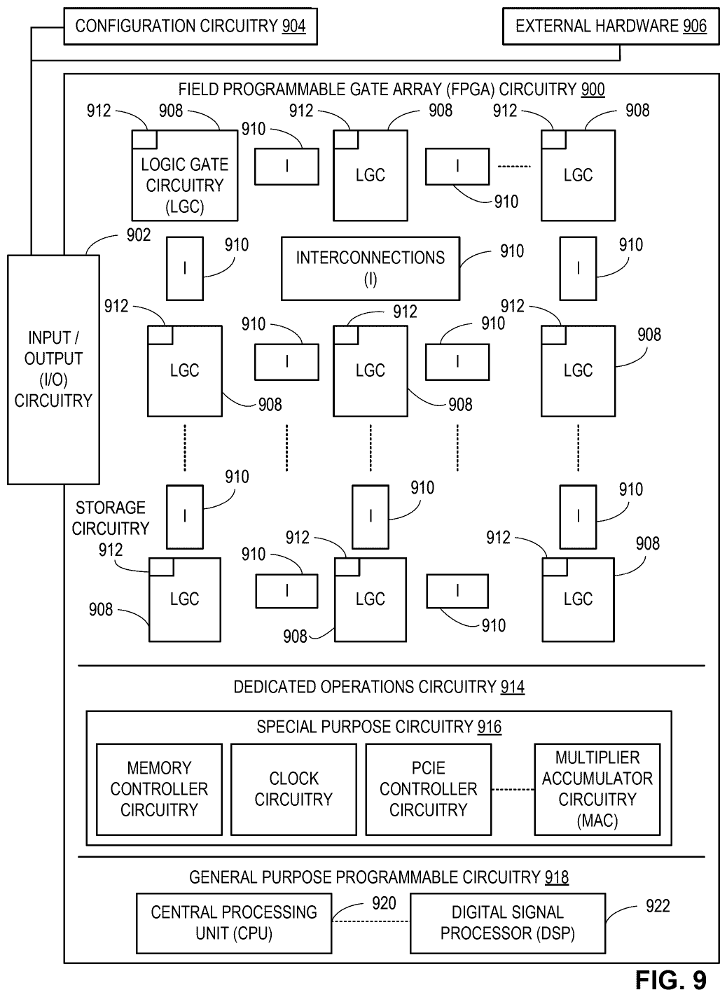

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 5 and 6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 5 and 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5 and 6. As such, the FPGA circuitry 900 may be configured and/or structured to effectively instantiate some or all of the operations/functions corresponding to the machine readable instructions of the flowchart(s) of FIGS. 5 and 6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 5 and 6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 5 and 6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 5 and 6 to perform first operation(s)/function(s), the FPGA circuitry 900 of FIG. 9 may be configured and/or structured to perform second operation(s)/function(s) corresponding to a second portion of the machine readable instructions represented by the flowcharts of FIGS. 5 and 6, and/or an ASIC may be configured and/or structured to perform third operation(s)/function(s) corresponding to a third portion of the machine readable instructions represented by the flowcharts of FIGS. 5 and 6.

It should be understood that some or all of the circuitry of FIG. 4 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 4 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 4 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

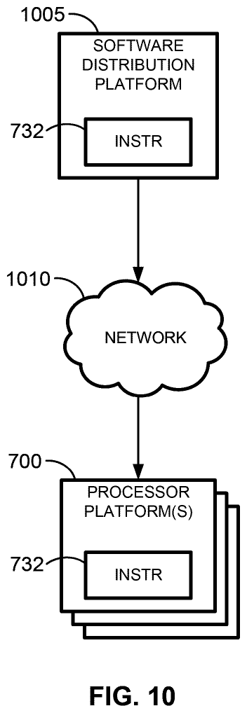

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 5 and 6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIGS. 5 and 6, may be downloaded to the example programmable circuitry platform 700, which is to execute the machine readable instructions 732 to implement the VM configuration analysis system 400. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

Example methods, apparatus, systems, and articles of manufacture to enable efficient and time-saving management of VMs and/or VM clusters/groupings are disclosed herein. Further examples and combinations thereof include the following:

Example 1 includes a system to manage a plurality of virtual machines of a shared computing resource, the system comprising interface circuitry, programmable circuitry, and machine readable instructions to cause the programmable circuitry to at least one of scan or monitor the plurality of virtual machines, determine whether a master application corresponding to the virtual machines has accepted a minion application corresponding to a first one of the virtual machines, and in response to the determination that the master application has not accepted the minion application, cause the master application to accept the minion application.

Example 2 includes the system as defined in example 1, wherein the programmable circuitry is to scan the virtual machines for a corresponding minion application installed thereon, and install a minion application on each of the virtual machines not having a minion application installed thereon.

Example 3 includes the system as defined in example 1, wherein the programmable circuitry is to determine whether the master application is installed on at least one of the virtual machines, and install the master application on the at least one of the virtual machines upon determination that none of the virtual machines has the master application installed thereon.

Example 4 includes the system as defined in example 1, wherein the programmable circuitry is to cause the master to accept the minion application by directing the master application to accept a key of the minion application.

Example 5 includes the system as defined in example 1, wherein the programmable circuitry is to scan the minion application to determine whether the minion application is properly configured, and in response to the minion application not being properly configured, configure the minion application.

Example 6 includes the system as defined in example 1, wherein the programmable circuitry is to scan each minion application of the virtual machines for compliance.

Example 7 includes the system as defined in example 6, wherein the programmable circuitry is to enforce compliance policies of each of the minion applications by providing an enforcement request to a configuration service.

Example 8 includes the system as defined in example 7, wherein the programmable circuitry is to determine whether the master application has accepted the minion application in response to the enforcement request being provided to the configuration service.

Example 9 includes a non-transitory machine readable storage medium comprising instructions to cause programmable circuitry to at least at least one of scan or monitor a plurality of virtual machines of a shared computing resource, determine whether a master application corresponding to the virtual machines has accepted a minion application corresponding to a first one of the virtual machines, and in response to the determination that the master application has not accepted the minion application, cause the master application to accept the minion application.

Example 10 includes the non-transitory machine readable storage medium as defined in example 9, wherein the instructions cause the programmable circuitry to scan the virtual machines for a corresponding minion application installed thereon, and install a minion application on each of the virtual machines not having a minion application installed thereon.

Example 11 includes the non-transitory machine readable storage medium as defined in example 9, wherein the instructions cause the programmable circuitry to determine whether the master application is installed on at least one of the virtual machines, and install the master application on the at least one of the virtual machines upon determination that none of the virtual machines has the master application installed thereon.

Example 12 includes the non-transitory machine readable storage medium as defined in example 9, wherein the instructions cause the programmable circuitry to direct the master application to accept a key of the minion application.

Example 13 includes the non-transitory machine readable storage medium as defined in example 9, wherein the instructions cause the programmable circuitry to determine whether the minion application is properly configured, and in response to the minion application not being properly configured, configure the minion application.

Example 14 includes the non-transitory machine readable storage medium as defined in example 9, wherein the programmable circuitry is to scan each minion application of the virtual machines for compliance.

Example 15 includes the non-transitory machine readable storage medium as defined in example 14, wherein the instructions cause the programmable circuitry to enforce compliance policies of each minion application of the shared computing resource by providing an enforcement request to a configuration service.

Example 16 includes the non-transitory machine readable storage medium as defined in example 15, wherein the instructions cause the programmable circuitry to determine whether the master application has accepted the minion application in response to the enforcement request being provided to the configuration service.

Example 17 includes a method comprising at least one of scanning or monitoring, by executing instructions with programmable circuitry, a plurality of virtual machines of a shared computing resource, determining, by executing instructions with the programmable circuitry, whether a master application corresponding to the virtual machines has accepted a minion application corresponding to a first one of the virtual machines, and in response to the determination that the master application has not accepted the minion application, causing, by executing instructions with the programmable circuitry, the master application to accept the minion application.

Example 18 includes the method as defined in example 17, further including scanning, by executing instructions with the programmable circuitry, the virtual machines for a corresponding minion application installed thereon, and installing, by executing instructions with the programmable circuitry, a minion application on each of the virtual machines not having a minion application installed thereon.

Example 19 includes the method as defined in example 17, further including determining, by executing instructions with the programmable circuitry, whether the master application is installed on at least one of the virtual machines, and installing, by executing instructions with the programmable circuitry, the master application on the at least one of the virtual machines upon determination that none of the virtual machines has the master application installed thereon.

Example 20 includes the method as defined in example 17, further including causing, by executing instructions with the programmable circuitry, the master application to accept a key of the minion application.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable timesaving, efficient and effective control of VM implementations/enterprises across shared computing resources. Examples disclosed herein can scale VM implementations in a relatively quick manner and also enable more effective governance and/or compliance management. As a result, examples disclosed herein can also increase security of shared computing resources that utilize VMs. Disclosed systems, apparatus, articles of manufacture, and methods improve the efficiency of using a computing device by reducing non-compliance of shared resources and, thus, downtime and computing resources utilized to resolving such non-compliance. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A system to manage a plurality of virtual machines of a shared computing resource, the system comprising:
interface circuitry;
programmable circuitry; and
machine readable instructions to cause the programmable circuitry to:
at least one of scan or monitor the plurality of virtual machines;
determine whether a master application corresponding to the virtual machines has accepted a minion application corresponding to a first one of the virtual machines; and
in response to the determination that the master application has not accepted the minion application, cause the master application to accept the minion application.

2. The system as defined in claim 1, wherein the programmable circuitry is to:
scan the virtual machines for a corresponding minion application installed thereon; and
install a minion application on each of the virtual machines not having a minion application installed thereon.

3. The system as defined in claim 1, wherein the programmable circuitry is to:
determine whether the master application is installed on at least one of the virtual machines; and
install the master application on the at least one of the virtual machines upon determination that none of the virtual machines has the master application installed thereon.

4. The system as defined in claim 1, wherein the programmable circuitry is to cause the master application to accept the minion application by directing the master application to accept a key of the minion application.

5. The system as defined in claim 1, wherein the programmable circuitry is to:
scan the minion application to determine whether the minion application is properly configured, and
in response to the minion application not being properly configured, configure the minion application.

6. The system as defined in claim 1, wherein the programmable circuitry is to scan each minion application of the virtual machines for compliance.

7. The system as defined in claim 6, wherein the programmable circuitry is to enforce compliance policies of each of the minion applications by providing an enforcement request to a configuration service.

8. The system as defined in claim 7, wherein the programmable circuitry is to determine whether the master application has accepted the minion application in response to the enforcement request being provided to the configuration service.

9. A non-transitory machine readable storage medium comprising instructions to cause programmable circuitry to at least:
at least one of scan or monitor a plurality of virtual machines of a shared computing resource;
determine whether a master application corresponding to the virtual machines has accepted a minion application corresponding to a first one of the virtual machines; and
in response to the determination that the master application has not accepted the minion application, cause the master application to accept the minion application.

10. The non-transitory machine readable storage medium as defined in claim 9, wherein the instructions cause the programmable circuitry to:
scan the virtual machines for a corresponding minion application installed thereon; and
install a minion application on each of the virtual machines not having a minion application installed thereon.

11. The non-transitory machine readable storage medium as defined in claim 9, wherein the instructions cause the programmable circuitry to:
determine whether the master application is installed on at least one of the virtual machines; and
install the master application on the at least one of the virtual machines upon determination that none of the virtual machines has the master application installed thereon.

12. The non-transitory machine readable storage medium as defined in claim 9, wherein the instructions cause the programmable circuitry to direct the master application to accept a key of the minion application.

13. The non-transitory machine readable storage medium as defined in claim 9, wherein the instructions cause the programmable circuitry to:
determine whether the minion application is properly configured; and
in response to the minion application not being properly configured, configure the minion application.

14. The non-transitory machine readable storage medium as defined in claim 9, wherein the programmable circuitry is to scan each minion application of the virtual machines for compliance.

15. The non-transitory machine readable storage medium as defined in claim 14, wherein the instructions cause the programmable circuitry to enforce compliance policies of each minion application of the shared computing resource by providing an enforcement request to a configuration service.

16. The non-transitory machine readable storage medium as defined in claim 15, wherein the instructions cause the programmable circuitry to determine whether the master application has accepted the minion application in response to the enforcement request being provided to the configuration service.

17. A method comprising:
at least one of scanning or monitoring, by executing instructions with programmable circuitry, a plurality of virtual machines of a shared computing resource;
determining, by executing instructions with the programmable circuitry, whether a master application corresponding to the virtual machines has accepted a minion application corresponding to a first one of the virtual machines; and
in response to the determination that the master application has not accepted the minion application, causing, by executing instructions with the programmable circuitry, the master application to accept the minion application.

18. The method as defined in claim 17, further including:
scanning, by executing instructions with the programmable circuitry, the virtual machines for a corresponding minion application installed thereon; and
installing, by executing instructions with the programmable circuitry, a minion application on each of the virtual machines not having a minion application installed thereon.

19. The method as defined in claim 17, further including:
determining, by executing instructions with the programmable circuitry, whether the master application is installed on at least one of the virtual machines; and
installing, by executing instructions with the programmable circuitry, the master application on the at least one of the virtual machines upon determination that none of the virtual machines has the master application installed thereon.

20. The method as defined in claim 17, further including causing, by executing instructions with the programmable circuitry, the master application to accept a key of the minion application.
